(19) United States
(12) Patent Application Publication
(10) Pub. No.: US 2025/0238865 A1
(43) Pub. Date: Jul. 24, 2025

(54) DEAL FLOW MANAGER WITH GRAPHICAL USER INTERFACE

(71) Applicant: The Machine, LLC, New York, NY (US)

(72) Inventors: Jeff Rinehart, New York, NY (US); Josh Cohen, New York, NY (US); Rohan Nair, New York, NY (US)

(21) Appl. No.: 18/416,786

(22) Filed: Jan. 18, 2024

(51) Int. Cl. G06Q 40/06

(52) U.S. Cl. CPC G06Q 40/06

(57) ABSTRACT

Embodiments of the present invention provide a novel approach to deal flow management that can manage multiple aspects of deal-making and investment in private sector companies and other entities (e.g., organizations, non-profits, NGOs, etc.). The deal flow management is displayed and controlled using a custom user interface (UI or GUI) to implement an AI-driven analytic investment process. In this way, the process of initiating deals with those companies and beginning a dialog for potential investment (“deal flow”) can be managed by fewer people using fewer resources. Some embodiments are particularly useful when a firm is investing in several different companies and desires a technology-augmented approach to manage the volume of work that comes with investing at that scale, among other advantages that will be described in further detail below according to various embodiments.

### CROSS-REFERENCE TO RELATED APPLICATIONS

The present application is related to copending U.S. patent application Ser. No. ______, filed ______, and having attorney docket number CTYL-0002-01.01US, which is herein incorporated by reference in its entirety for all purposes.

### FIELD

Embodiments of the present invention generally relate to the field of investment, financial planning, or analysis. More specifically, embodiments of the present invention relate to tools for the management and display of information for financial planning and investment.

### BACKGROUND

Existing approaches to private-sector investment in companies, including startups, require a substantial investment of time and human resources to identify companies that meet certain requirements or preferences based on financial planning and manual analysis of vast amounts of data. There are typically thousands of potential entities that private-sector investment firms can target for investment, with new companies being created every day.

Beyond merely identifying companies and other entities that could be a good fit for a particular investment firm, investment firms also determine the appropriate way to make contact with these companies, and build relationships with those contacts, in a way that is organized, efficient, and productive. Unfortunately, existing approaches to these tasks often involve manually looking up or otherwise identifying contact points and key data from publicly available information and other third-party sources, which typically involves sifting through large amounts of data, essentially looking for a small amount of candidates that meet prescribed criteria. A more streamlined approach to identifying investment targets, managing contacts, and building relationships with those targets is needed.

### SUMMARY

Accordingly, embodiments of the present invention provide a novel approach to deal flow management that can manage multiple aspects of deal-making and investment in private sector companies and other entities (e.g., organizations, charities, non-profits, NGOs, etc.). Embodiments of the graphical user interfaces disclosed herein can be used to manage and review processes and tasks of team members efficiently and effectively, and to manage deal flow until connections with selected companies are complete. Some steps of the deal flow process, such as outreach assignment and the initial review of companies, are automated and can be performed using an AI-driven approach based on predefined investment criteria.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a diagram depicting an exemplary on-screen GUI of a deal-flow management system for reviewing recommended companies according to embodiments of the present invention.

FIG. 2 is a diagram depicting an exemplary on-screen GUI of a deal-flow management system showing companies that have been reviewed and marked as fit according to embodiments of the present invention.

FIG. 3 depicts an exemplary on-screen GUI of a deal-flow management system for manually assigning a team member to a task according to embodiments of the present invention.

FIG. 4 depicts an exemplary on-screen GUI of a deal-flow management system for manually assigning a team member to a task using a drop-down menu according to embodiments of the present invention.

FIG. 5 is a diagram depicting an exemplary on-screen GUI showing team member assignments for company outreach tasks according to embodiments of the present invention.

FIG. 6 is a diagram depicting an exemplary on-screen GUI for showing detailed company information including general company information (e.g., contact information) according to embodiments of the present invention.

FIG. 7 is a diagram depicting an exemplary on-screen GUI for showing detailed company information including financial information (e.g., total funding) according to embodiments of the present invention.

FIG. 8 is a flowchart depicting an exemplary computer-implemented process for automatically managing a deal flow process that can be used to evaluate investment targets and automate outreach and other tasks through deal flow completion according to embodiments of the present invention.

FIG. 9 is a block diagram depicting an exemplary computer system platform upon which embodiments of the present invention may be implemented.

### DETAILED DESCRIPTION

Reference will now be made in detail to several embodiments. While the subject matter will be described in conjunction with the alternative embodiments, it will be understood that they are not intended to limit the claimed subject matter to these embodiments. On the contrary, the claimed subject matter is intended to cover alternative, modifications, and equivalents, which may be included within the spirit and scope of the claimed subject matter as defined by the appended claims.

Furthermore, in the following detailed description, numerous specific details are set forth in order to provide a thorough understanding of the claimed subject matter. However, it will be recognized by one skilled in the art that embodiments may be practiced without these specific details or with equivalents thereof. In other instances, well-known methods, procedures, components, and circuits have not been described in detail as not to unnecessarily obscure aspects and features of the subject matter.

Some embodiments may be described in the general context of computer-executable instructions, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

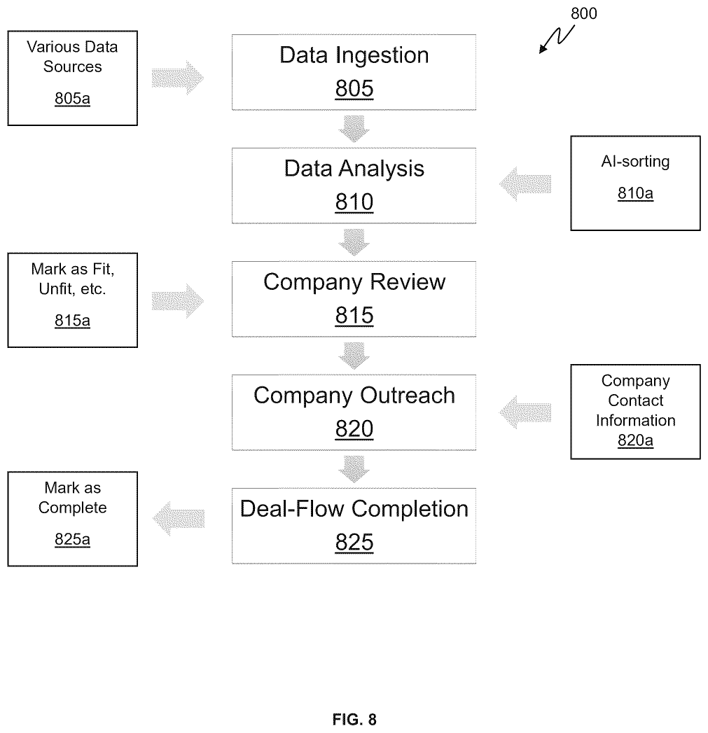

Portions of the detailed description that follow are presented and discussed in terms of a method. Although steps and sequencing thereof are disclosed in a figure herein (e.g., FIG. 8) describing the operations of this method, such steps and sequencing are exemplary. Embodiments are well suited to performing various other steps or variations of the steps recited in the flowchart of the figure herein, and in a sequence other than that depicted and described herein.

Some portions of the detailed description are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout, discussions utilizing terms such as “accessing,” “configuring,” “coordinating,” “storing,” “transmitting,” “authenticating,” “identifying,” “requesting,” “reporting,” “determining,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### Novel Deal Flow Management for Identification, Contact, and Investment in Companies

Embodiments of the present invention provide a novel approach to deal flow management that can manage and automate multiple aspects of deal-making and investment in private sector companies and other entities (e.g., organizations, non-profits, NGOs, etc.). Deal flow management information is displayed and controlled using a custom user interface (UI or GUI) that implements an AI-driven analytic investment process. In this way, the process of initiating deals with target companies and beginning a dialog for potential investment (“deal flow”) can be managed by fewer people using fewer resources. Some embodiments are particularly useful when a firm is investing in several different companies and desires a technology-augmented approach to manage the volume of work that comes with investing at large scales, among other advantages that will be described in further detail below according to various embodiments.

One aspect of the present invention involves an AI-driven approach to sorting through hundreds of thousands of companies periodically (e.g., one per week, once per month, etc.) and performing analytical assessment on each company that potentially fits certain predefined investment criteria. The identified companies (“recommended companies”) can then be provided to an investor or team members (e.g., employees of an investment firm, an account manager, etc.). Companies can also be identified using more conventional means, like recommendations from a network of resources (peers, consultants, etc.), company research, conferences, meeting notes, etc. Combining these different sources using an AI-driven sorting approach typically yields hundreds of companies for further review each month. This large volume of information leads to a potentially time-consuming process, especially when the information is somewhat informal and lacks clear, concise, and complete information that is readily actionable for making a confident assessment.

Accordingly, embodiments of the present invention can automatically ingest potential candidate companies for further review from any data source, including conference attendee lists, networked-sourced deals, third-party recommendation lists, etc., as long as the basic information for each company can be organized in a row-column format (csv, Excel, Google Sheet, etc.). Moreover, embodiments of the graphical user interfaces disclosed herein can be used to manage and review processes and tasks of team members efficiently and effectively, and to manage deal flow until connections with selected companies are complete.

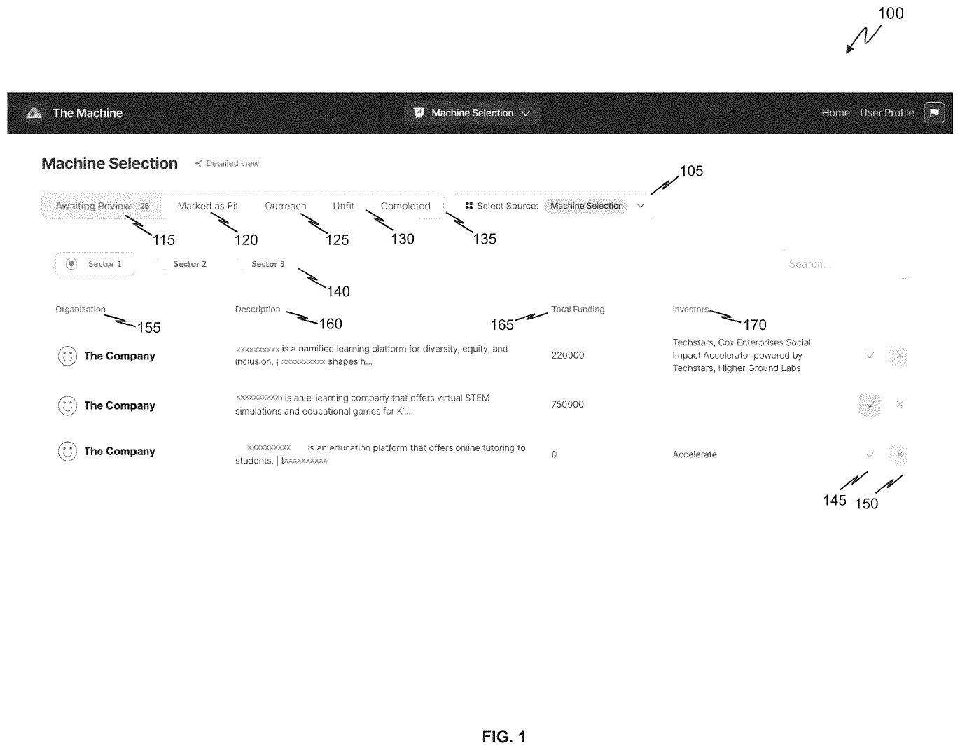

FIG. 1 depicts an exemplary on-screen GUI 100 of a deal-flow management system for reviewing recommended companies according to embodiments of the present invention. GUI 100 may be considered the top-level of an overall user interface, and includes data for several organizations (e.g., companies) displayed from a selected data source. The data source can be selected using source select menu 105. In the example of FIG. 1, an AI-driven machine selection of company data is selected for display, for example, as described in more detail in related application CTYL-0002-01.01US, referenced above. Other exemplary data sources include team networks, research databases, etc. Several display tabs are presented on GUI 100 that can be selected to change the company information displayed, including companies awaiting review 115, companies that have been reviewed and marked as fit 120, companies identified as needing outreach 125 (e.g., initial contact/discussion), companies that have been reviewed and marked as unfit 130, and companies that have completed the deal-flow process 135.

The example of FIG. 1 shows optional category selection buttons 140 that categorizes companies based on the associated area of interest, in this example, Sector 1, Sector 2, and Sector 3. Companies can be organized in any way that a firm would like that makes review easier for team members, managers, etc. A particular category (e.g., area of interest) can be selected to show companies from the selected category. Examples of categories include Education, Climate, Healthcare, etc. This is particularly useful if a team has members that focus mostly on particular areas. A check mark 145 (YES) or X button 150 (NO) can be selected by a user to indicate whether a particular company warrants further review from the team or not for investment purposes, in which case the company is added to the “Marked as Fit” category. The selection of YES or NO can also be toggled using a specific keyboard key, for example. If a user wants more detailed information on a company, detailed view button 155 can be selected at the top of GUI 100.

As mentioned above, an AI-driven approach to sorting companies can periodically perform analytical assessment of companies that potentially fit certain predefined criteria. Company data is typically ingested from various data sources (e.g., conference attendee lists, networked-sourced deals, third-party recommendation lists, meeting notes, transcripts, interviews) and organized in a row-column format. The recommended companies can then be provided via GUI 100, and GUI 100 can be configured to display any number of relevant metrics, graphs, projections, opinions, etc., ingested from the data sources. In the example of FIG. 1, the organization name 155, general description 160, total funding 165, and current investors are displayed for each company 170, although any other relevant company information can be displayed, according to embodiments.

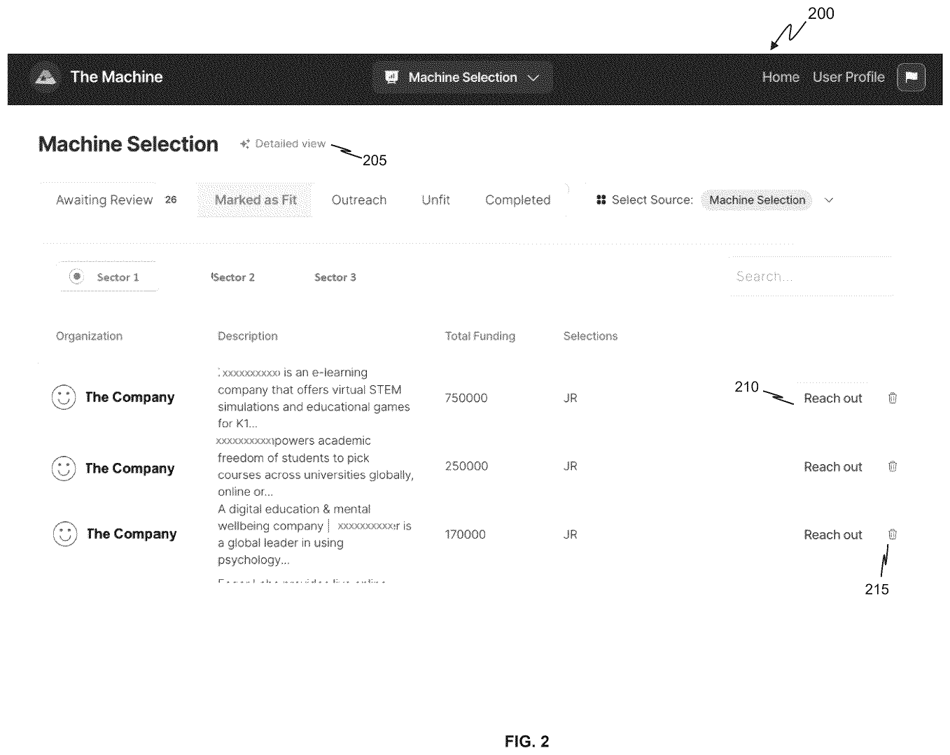

FIG. 2 depicts an exemplary on-screen GUI 200 of a deal-flow management system showing companies that have been reviewed and marked as fit according to embodiments of the present invention. The exemplary GUI of FIG. 2 is especially useful when used for review by a broader team in an attempt to reach a consensus that a particular company that has been marked as fit is desirable from an investment perspective, before a team member is committed to reach out to the company. GUI 200 is intended to facilitate the discussion process so that a collective decision can be reached quickly and efficiently. As with the example of FIG. 1, detailed view button 205 can be selected to show additional information of a selected company.

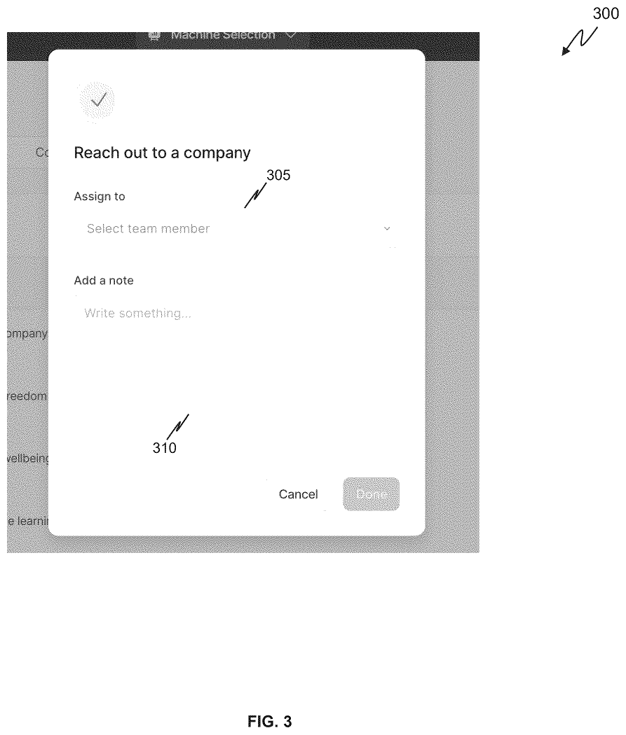

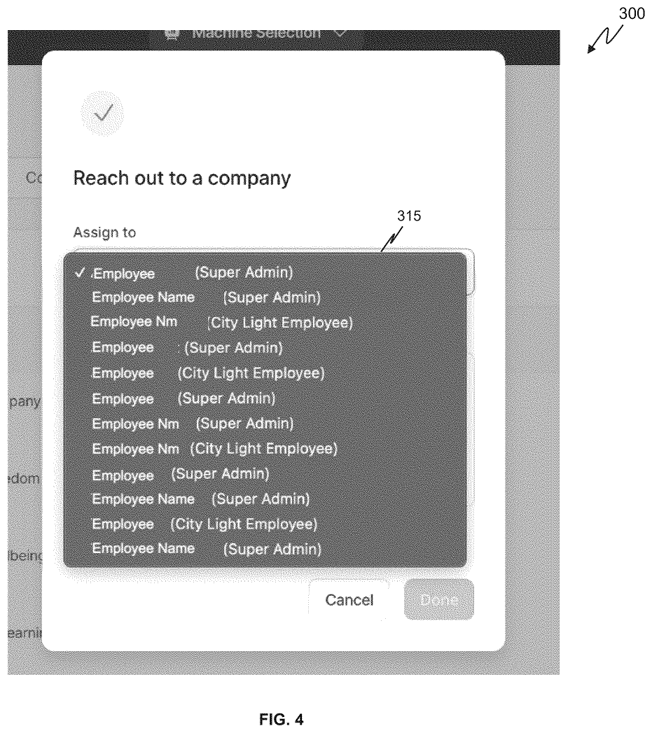

As shown in the example of FIG. 2, rather than a check mark selection, GUI 200 further includes task assignment buttons 210 that can be selected to assign a particular action to a team member. For example, reach out button can be selected to assign the task of initiating communication with a particular company (“reaching out”) to a team member. The team member assignment can include automatically assigning the task to a team member based on predetermined criteria (e.g., based on which team member has a preexisting relationship of other path to communication), or displaying a team member selection menu, as shown in the examples of FIGS. 3, 4. The predetermined criteria can include using a social graph that represents relationships and connections between internal and external teams. The recommendations made can then be accepted or overridden by a manual team member selection. If a decision is made not to reach out to a company, the company can be deleted from the marked as fit category by selecting the respective trash can icon 215.

FIGS. 3, 4 depict an exemplary on-screen GUI 300 of a deal-flow management system for manually assigning a team member to a task (e.g., outreach) according to embodiments of the present invention. GUI 300 includes a task assignment menu 305 and an optional note entry field 310 that can be used to send a note to the selected team member. When the task assignment menu 305 is selected, a list of potential team members 315 is displayed for selection, as shown in FIG. 4.

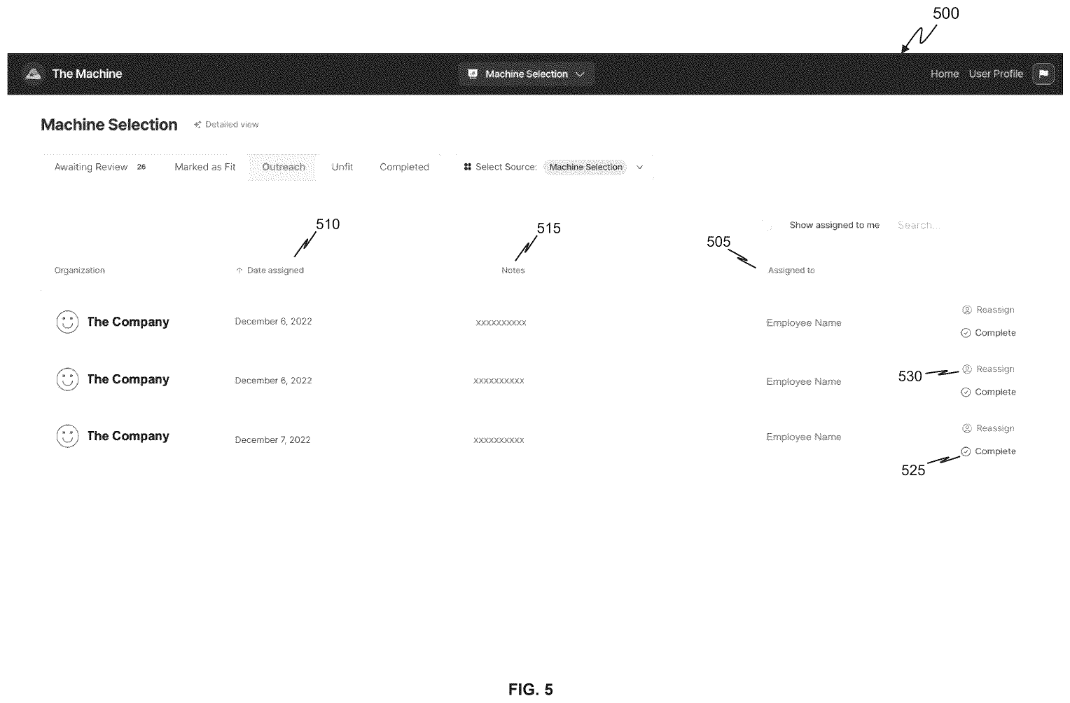

A newly created task assignment can then be automatically added to an outreach GUI 500 as depicted in the example of FIG. 5, which shows the team member assignment 505, date assigned 510, and any added notes 515 (e.g., reach out to John Doe who was a previous investor) relevant to company outreach, according to embodiments of the present invention. Toggle button 520 can be selected to configure exemplary on-screen GUI 500 to only show outreach tasks assigned to the current user. Moreover, outreach complete indicators 525 are displayed when a particular outreach task is complete, and each outreach task can be displayed on GUI 500 can be reassigned by selecting a reassignment button 530.

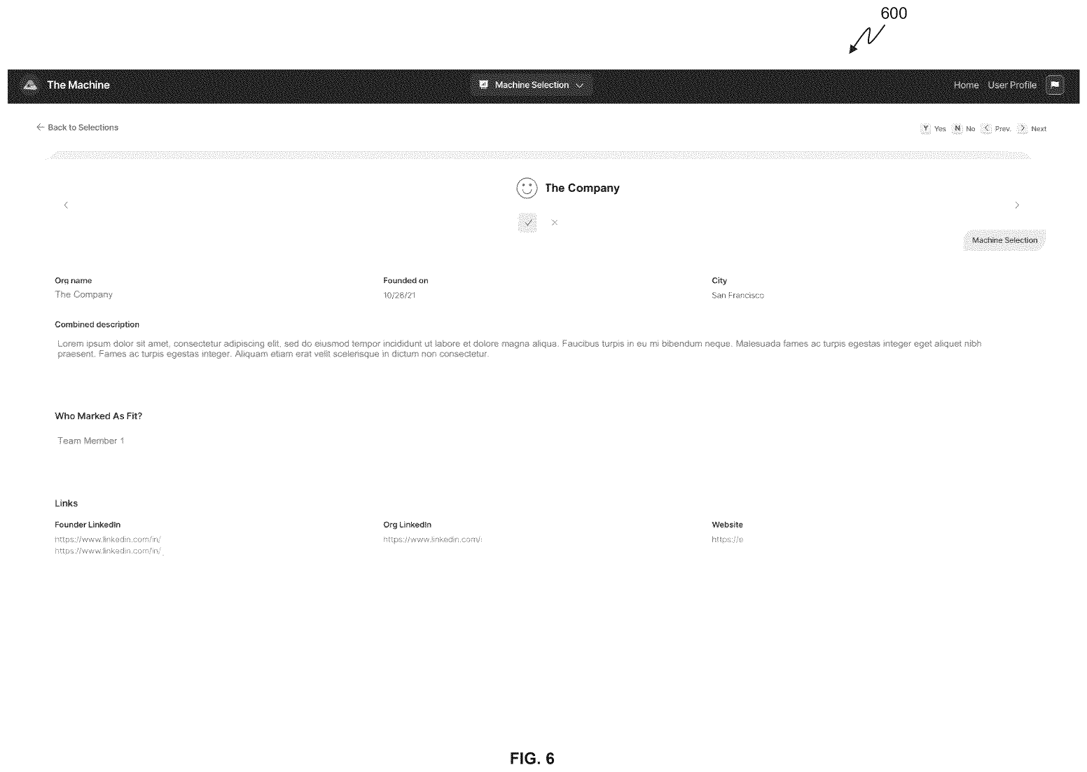

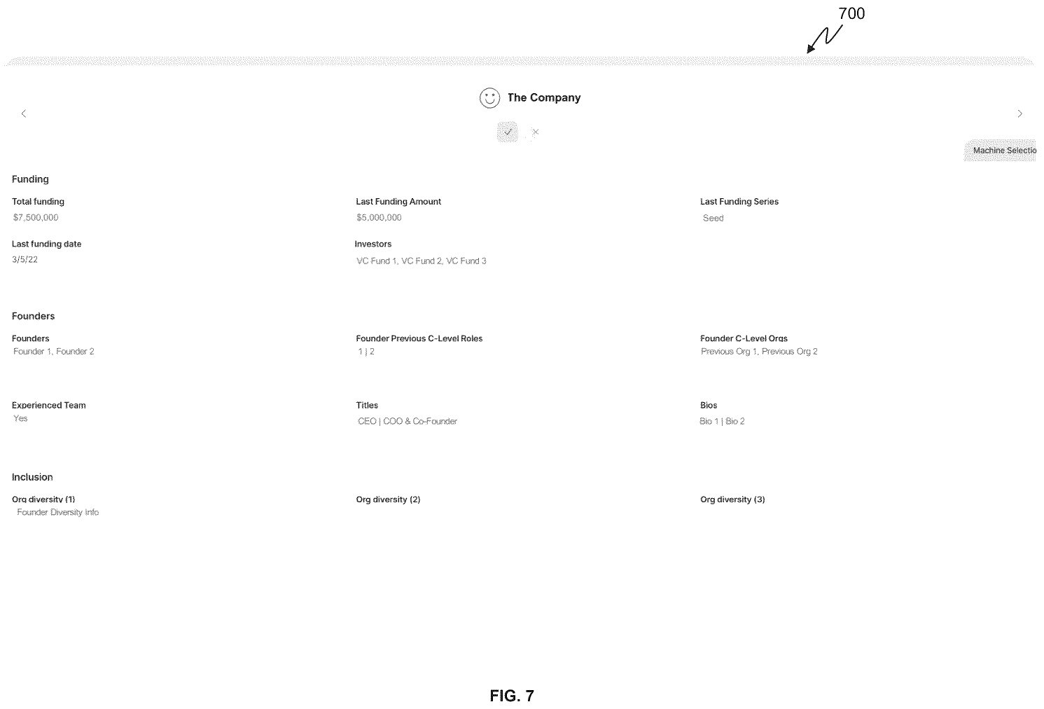

As mentioned above, more information pertaining to a selected company can be displayed by selecting a detailed view button. FIGS. 6, 7 show exemplary on-screen GUIs 600 and 700, respectively, for showing detailed information relevant to investment analysis, outreach, etc. In the example of FIG. 6, on-screen GUI 600 displays detailed company information in a way that provides all of the pertinent information needed to make an assessment about a company organized in a clean and easily understandable way. Importantly, users can move through each company entirely from their keyboard without needing to move a mouse to a specific area of GUI 600, which can significantly improve the speed of the assessment process. For example, according to some embodiments, users can quickly move through companies by pressing the left or right arrow keys and entering a “yes” or “no” decision by pressing the “Y” or “N” keys. For companies where further communication is warranted (selected by clicking a check mark or clicking ‘Y’ on the keyboard), the company automatically moves to the Marked as Fit GUI (e.g., FIG. 2).

Importantly, GUIs 600, 700 show company information organized in relevant sections, with key information presented cleanly on page, including relevant hyperlinks that can be selected to access third-party information, typically websites, PDFs, etc. (e.g., company website and founder LinkedIn pages). The clean, concise and complete layouts above enable users to review hundreds of potential companies in a fairly short time period, making assessments on whether a particular company warrants additional conversations with the team. Advantageously, fewer team members are needed to sort through the company information to make a decision (e.g., mark as fit), and the outreach process is automated and streamlined to further improve the efficiency of private sector investment using the novel GUIs disclosed herein.

More specifically, on-screen GUI 600 depicted in FIG. 6 shows general company information, such as the organization name, the date the company was founded, the city where the company is located, a general description of the company, which team member marked the company as fit, and relevant links, including links to the company founders social media (e.g., LinkedIn), a link to the organizations social media, and a link to the company's website. GUI 700 shows an example of more detailed investment information, including funding information, founder information, and inclusion and diversity information. The information displayed in GUIs 600 and 700 is only exemplary, and the GUIs can be configured to display any relevant company information accessible from various data sources as described above and in the related application CTYL-0002-01.01 referenced herein.

FIG. 8 is a flowchart depicting an exemplary computer-implemented process 800 for automatically managing a deal flow process that can be used to evaluate investment targets and automate outreach and other tasks through deal flow completion according to embodiments of the present invention. As explained above and in detail in related application CTYL-0002-01.01, some steps of process 800 include ingesting large volumes of company data from various sources, and using algorithms (e.g., artificial intelligence algorithms, machine learning, neural networks, learned language models, etc.) to parse, sort, filter, and/or rank companies based on the ingested information. For example, process 800 can include using an AI algorithm to access and identify (“scrape”) data from various data sources, and sort the data into easily digestible information (e.g., in a column and row format). Based on the AI-driven data acquired during process 800, companies can be marked as fit for further action, such as outreach, and eventually a deal is completed, which may include investment, lending, acquisition, etc.

Process 800 begins at step 805, data ingestion, which typically includes accessing data from various sources 805a. Step 800 can include automatically ingesting potential candidate companies for further review from any data source, including conference attendee lists, networked-sourced deals, third-party recommendation lists, etc. The information is typically organized in a row-column format (csv, Excel, Google Sheet, etc.).

At step 810, data analysis is performed on companies that potentially fit certain predefined criteria. The identified companies (“recommended companies”) can then be provided to an investor or team members (e.g., employees of an investment firm, an account manager, etc.). Companies can be identified using AI-sorting 810a, as well as using more conventional means, like recommendations from a network of resources (peers, consultants, etc.), company research, conferences, meeting notes, etc. Steps 805 and 810 can be performed periodically (e.g., once a month) to present team members and investors a fresh list of potential investment targets as new companies are formed and more information comes available. The result of data analysis 810 is a list of potential investment targets (e.g., companies and other organizations) and significant amounts of company data.

At step 815, the list of potential investment targets is reviewed manually by employees of an investment firm, for example. The GUIs described herein according to the various embodiments can be used to sort, filter, and rank the companies, and detailed company information can be accessed using the interface. Once the relevant company information has been reviewed, a checkmark can be selected to mark the company as fit for outreach/investment, or marked as unfit (815a). Moreover, companies can be quickly selected and marked as fit or unfit using arrow keys and other hotkeys, according to embodiments, which saves time and resources when periodically assessing dozens or hundreds of companies at a time.

At step 820, a company outreach process is performed, which can be automated to automatically assign a company to a team member based on predefined criteria (e.g., existing contacts and relationships). Company contact information 820a can be obtained from various sources, such as publicly available websites, social media, company directories, news and media articles, etc. Companies can also be manually assigned to employees using the novel GUI described here.

At step 825, when the outreach process has been completed successfully, the deal reaches completion and the corresponding deal is marked as complete. Otherwise, if the deal has not completed successfully (e.g., outreach was unsuccessful), the company can optionally be reassigned to another team member.

### Exemplary Computer Controlled System

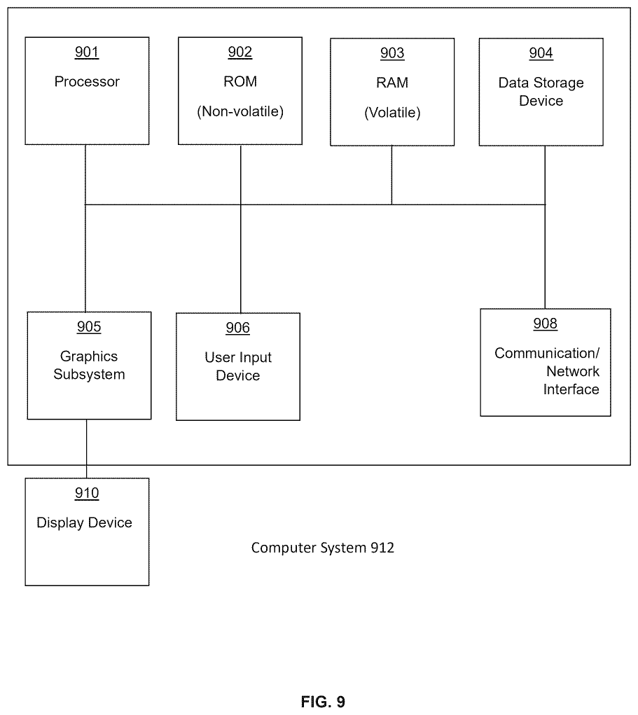

Embodiments of the present invention are drawn to systems and methods of deal flow management that can manage multiple aspects of deal-making and investment in private sector companies and other entities (e.g., organizations, non-profits, NGOs, etc.) automatically using a computer system. Deal flow management information and tools are displayed on a display device and controlled using a custom user interface to implement an AI-driven analytic investment process. In this way, the process of initiating deals with those companies and beginning a dialog for potential investment can be managed by fewer people using fewer resources. One exemplary computer system for deal flow management is described below with respect to FIG. 9.

In the example of FIG. 9, the exemplary computer system 912 includes a central processing unit (such as a processor or a CPU) 901 for running software applications and typically an operating system. Read-only memory 902 and random access memory 903 store applications and data for use by the CPU 901. Data storage device 904 provides non-volatile storage for applications and data and may include fixed disk drives, removable disk drives, flash memory devices, and CD-ROM, DVD-ROM or other optical storage devices. The optional user input 906 comprises devices that communicate inputs from one or more users to the computer system 912 (e.g., mice, joysticks, cameras, keyboards, touch screens, and/or microphones). A communication or network interface can be used to communicate electronically with a local and/or remote computer network, such as the Internet.

The display device 910 may be any device capable of displaying visual information in response to a signal from the computer system 912. The components of the computer system 912, including the CPU 901, memory 902/903, data storage 904, user input devices 906, and optional graphics subsystem 905 may be coupled via one or more data buses.

Embodiments of the present invention are thus described. While the present invention has been described in particular embodiments, it should be appreciated that the present invention should not be construed as limited by such embodiments, but rather construed according to the following claims.

What is claimed is:

1. A method for evaluating company information displayed on a graphical user interface (GUI) of a computer system for investment purposes, said method comprising:
ingesting company information from a plurality of data sources;
formatting the company information into a structured format;
identifying companies as potential investment targets based on the company information;
displaying the potential investment targets on a first on-screen GUI rendered on a display device of the computer system;
receiving, via the first on-screen GUI, an input indicating that a first company of the plurality of companies is fit for investment; and
responsive to the input, removing the first company from the first on-screen GUI and displaying the first company on a second on-screen GUI rendered on the display device, wherein the second on-screen GUI is operable to display companies of the plurality of companies that are fit for investment.

2. The method of claim 1, wherein the first on-screen GUI is operable to show a list of companies that are awaiting review based on the company information and categorized based on company area of interest, and wherein the first on-screen GUI comprises a check mark graphical element that can be user selected to indicate that a particular company awaiting review is marked as fit for investment.

3. The method of claim 2, wherein the check mark graphical element is operable to be user selected by entering a keystroke using a keyboard.

4. The method of claim 1, wherein the first on-screen GUI comprises a detailed view button that launches a third on-screen GUI operable to display detailed company information.

5. The method of claim 4, wherein the third on-screen GUI is operable to select a next company or a previous company by entering a keystroke using a keyboard.

6. The method of claim 1, further comprising automatically marking the company as fit, removing the first company from the first on-screen GUI and displaying the first company on the second on-screen GUI rendered on the display device without waiting for the input indicating that the first company of the plurality of companies is fit for investment.

7. The method of claim 1, wherein the identifying companies as potential investment targets based on the company information comprises receiving recommendation data from an AI-driven algorithm.

8. The method of claim 1, wherein the first on-screen GUI comprises an interface button operable to launch a second on-screen GUI, wherein the second on-screen GUI displays a list of companies that are marked as fit for investment.

9. The method of claim 8, wherein the second on-screen GUI comprises a second interface button operable to assign an outreach task associated with a company displayed on the second on-screen GUI to a user.

10. The method of claim 9, wherein the user is automatically selected for assignment based on predefined outreach criteria.

11. A method of company outreach using a graphical user interface (GUI) of a computer system, said method comprising:
ingesting company contact information;
formatting the company information in a structured format;
identifying a plurality of companies as fit for investment based on predefined investment criteria;
receiving, via an on-screen GUI, an input indicating that a first company of the plurality of companies is selected for outreach;
responsive to the input, automatically identifying a contact person based on the company contact information and displaying the contact person on the on-screen GUI; and
assigning an outreach task to a user, wherein the outreach task comprises contacting the contact person to make a potential investment in the first company.

12. The method of claim 11, wherein the company contact information comprises at least one of: a social media profile; and a company directory.

13. The method of claim 11, wherein the company contact information comprises a social graph comprising relationship information.

14. The method of claim 11, wherein the company contact information comprises a media article.

15. The method of claim 11, further comprising automatically identifying a plurality of companies as fit for investment based on company information ingested from a plurality of data sources using an AI-driven algorithm.

16. The method of claim 11, wherein the assigning an outreach task to a user comprises automatically selecting the user based on predefined outreach criteria.

17. The method of claim 11, wherein the assigning an outreach task to a user comprises selecting a particular user from a list of users displayed on the on-screen GUI based on contacts between the company contact information and the users.

18. A computer system, comprising:
a processor;
a memory coupled to the processor, wherein the memory is operable to store company information of potential investment targets; and
a display device coupled to the processor, wherein the display device is operable to render an on-screen graphical user interface (GUI) according to instructions received from the processor, wherein the on-screen GUI comprises:
a first on-screen area operable to display companies awaiting review, wherein the companies awaiting review are categorized by company area of interest;
a second on-screen area operable to display companies marked as fit for investment; and
a third on-screen area operable to display companies marked as outreach targets, wherein the companies marked as outreach targets are associated with a contact person and assigned to a user as an outreach task.

19. The computer system of claim 18, wherein the companies awaiting review displayed on the first on-screen area companies are generated by an AI-driven algorithm according to predefined investment criteria.

20. The computer system of claim 18, wherein the processor is operable to automatically ingest company information from a plurality of data sources, wherein the outreach targets are automatically assigned to a user, and wherein the contact person is automatically identified based on the company information.
